(19) United States
(12) Patent Application Publication
(10) Pub. No.: US 2026/0281762 A1
(43) Pub. Date: Sep. 17, 2026

(54) MACHINE LEARNING FOR DETERMINING REFERENCE SIGNAL TO BE USED BY A UE

(71) Applicant: Nokia Technologies Oy, Espoo (FI)

(72) Inventor: Keeth Saliya Jayasinghe Laddu, Espoo (FI)

(73) Assignee: Nokia Technologies Oy, Espoo (FI)

(21) Appl. No.: 19/472,755

(22) PCT Filed: Feb. 23, 2024
(86) PCT No.: PCT/EP2024/054594

§ 371 Date: Oct. 6, 2025

(30) Foreign Application Priority Data
Apr. 6, 2023 (GB) 2305150.1

(51) Int. Cl. H04W 24/08

(52) U.S. Cl. CPC H04W 24/08

(57) ABSTRACT

An apparatus comprising: means for performing, using a first set of reference signals and during a failure detection cycle, failure detection of a functionality associated with a machine learning model; means for receiving an indication of a second set of reference signals from a network during the failure detection cycle; means for measuring the second set of reference signals during the failure detection cycle; means for performing, using the second set of reference signals and during the failure detection cycle, failure detection of the functionality associated with the machine learning model.

### FIELD

The present application relates to a method, apparatus, system and computer program.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite-based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to a first aspect, there is provided an apparatus comprising: means for performing, using a first set of reference signals and during a failure detection cycle, failure detection of a functionality associated with a machine learning model; means for receiving an indication of a second set of reference signals from a network during the failure detection cycle; means for measuring the second set of reference signals during the failure detection cycle; means for performing, using the second set of reference signals and during the failure detection cycle, failure detection of the functionality associated with the machine learning model.

According to some examples, the apparatus comprises: means for receiving, from the network, an indication of the first set of reference signals and a time period for each failure detection cycle for performing the failure detection of the functionality associated with the machine learning model, wherein the indication is used to determine the first set of reference signals.

According to some examples, a Control Resource Set, CORESET, Quasi Co Location, QCL, resource is used to determine the first set of reference signals, wherein the apparatus comprises: means for receiving, from the network, a time period for each failure detection cycle for performing the failure detection of the functionality associated with the machine learning model.

According to some examples, after receiving the indication of the second set of reference signals, the means for performing, using the second set of reference signals from the network, the failure detection of the functionality associated with the machine learning model uses: only the second set of reference signals for performing the failure detection until an indication of a third set of reference signals is received.

According to some examples, after receiving the indication of the second set of reference signals, the means for performing, using the second set of reference signals from the network, the failure detection of the functionality associated with the machine learning model during the failure detection cycle uses: both the first set of reference signals and the second set of reference signals for performing the failure detection.

According to some examples, the indication of the second set of reference signals comprises: an indication comprising a list of reference signals to use as the second set of reference signals

According to some examples, the indication comprises a medium access control element or downlink control information.

According to some examples, the indication of the second set of reference signals comprises: a triggering command indicating that channel state information reference signal transmission should be used as the second set of reference signals.

According to some examples, the apparatus comprises: means for reporting at least one predicted beam to the network, wherein the indication of the second set of reference signals comprises an indication to use the at least one predicted beam as the second set of reference signals.

According to some examples, the means for performing, using the first set of reference signals and during the failure detection cycle, failure detection of the functionality associated with the machine learning model comprises at least one of: means for comparing predicted beams from the machine learning model with the first set of reference signals; means for comparing a measured Layer 1 Reference Signal Resource Indicator distribution of the first set of reference signals with an output distribution of the machine learning model.

An apparatus according to any preceding claim, wherein the means for performing, using the measured second set of reference signals during the failure detection cycle, failure detection of the functionality associated with the machine learning model comprises at least one of: means for comparing predicted beams from the machine learning model with the second set of reference signals; means for comparing a measured Layer 1 Reference Signal Resource Indicator distribution of the second set of reference signals with an output distribution of the machine learning model.

According to some examples, the apparatus comprises: means for sending, to the network, each model failure instance determined using the first set of reference signals; wherein the network determines to send the second set of reference signals based on the received model failure instances.

According to some examples, the second set of reference signals is based on a report, wherein the apparatus comprises means for sending the report to the network, the report comprising at least one of the following: at least one strongest beam predicted using the machine learning model; Layer 1 Reference Signal Received Power of one or more beams predicted using the machine learning model; Channel State Information.

According to a second aspect, there is provided a method comprising: performing, using a first set of reference signals and during a failure detection cycle, failure detection of a functionality associated with a machine learning model; receiving an indication of a second set of reference signals from a network during the failure detection cycle; measuring the second set of reference signals during the failure detection cycle; performing, using the second set of reference signals and during the failure detection cycle, failure detection of the functionality associated with the machine learning model.

According to some examples, the method comprises: receiving, from the network, an indication of the first set of reference signals and a time period for each failure detection cycle for performing the failure detection of the functionality associated with the machine learning model, wherein the indication is used to determine the first set of reference signals.

According to some examples, a Control Resource Set, CORESET, Quasi Co Location, QCL, resource is used to determine the first set of reference signals, wherein the method comprises: receiving, from the network, a time period for each failure detection cycle for performing the failure detection of the functionality associated with the machine learning model.

According to some examples, after receiving the indication of the second set of reference signals, performing, using the second set of reference signals from the network, the failure detection of the functionality associated with the machine learning model uses: only the second set of reference signals for performing the failure detection until an indication of a third set of reference signals is received.

According to some examples, after receiving the indication of the second set of reference signals, performing, using the second set of reference signals from the network, the failure detection of the functionality associated with the machine learning model during the failure detection cycle uses: both the first set of reference signals and the second set of reference signals for performing the failure detection.

According to some examples, the indication of the second set of reference signals comprises: an indication comprising a list of reference signals to use as the second set of reference signals

According to some examples, the indication comprises a medium access control element or downlink control information.

According to some examples, the indication of the second set of reference signals comprises: a triggering command indicating that channel state information reference signal transmission should be used as the second set of reference signals.

According to some examples, the method comprises: reporting at least one predicted beam to the network, wherein the indication of the second set of reference signals comprises an indication to use the at least one predicted beam as the second set of reference signals.

According to some examples, the performing, using the first set of reference signals and during the failure detection cycle, failure detection of the functionality associated with the machine learning model comprises at least one of: comparing predicted beams from the machine learning model with the first set of reference signals; comparing a measured Layer 1 Reference Signal Resource Indicator distribution of the first set of reference signals with an output distribution of the machine learning model.

According to some examples, performing, using the measured second set of reference signals during the failure detection cycle, failure detection of the functionality associated with the machine learning model comprises at least one of: comparing predicted beams from the machine learning model with the second set of reference signals; comparing a measured Layer 1 Reference Signal Resource Indicator distribution of the second set of reference signals with an output distribution of the machine learning model.

According to some examples, the method comprises: sending, to the network, each model failure instance determined using the first set of reference signals; wherein the network determines to send the second set of reference signals based on the received model failure instances.

According to some examples, the second set of reference signals is based on a report, wherein the method comprises sending the report to the network, the report comprising at least one of the following: at least one strongest beam predicted using the machine learning model; Layer 1 Reference Signal Received Power of one or more beams predicted using the machine learning model; Channel State Information.

According to a third aspect, there is provided an apparatus comprising at least one processor and at least one memory storing instructions that, when executed by the at least one processor, cause the apparatus at least to: performing, using a first set of reference signals and during a failure detection cycle, failure detection of a functionality associated with a machine learning model; receiving an indication of a second set of reference signals from a network during the failure detection cycle; measuring the second set of reference signals during the failure detection cycle; performing, using the second set of reference signals and during the failure detection cycle, failure detection of the functionality associated with the machine learning model.

According to some examples, the at least one memory and the computer program code are configured to, with the at least one processor, cause the apparatus at least to perform: receiving, from the network, an indication of the first set of reference signals and a time period for each failure detection cycle for performing the failure detection of the functionality associated with the machine learning model, wherein the indication is used to determine the first set of reference signals.

According to some examples, a Control Resource Set, CORESET, Quasi Co Location, QCL, resource is used to determine the first set of reference signals, wherein the at least one memory and the computer program code are configured to, with the at least one processor, cause the apparatus at least to perform: receiving, from the network, a time period for each failure detection cycle for performing the failure detection of the functionality associated with the machine learning model.

According to some examples, after receiving the indication of the second set of reference signals, performing, using the second set of reference signals from the network, the failure detection of the functionality associated with the machine learning model uses: only the second set of reference signals for performing the failure detection until an indication of a third set of reference signals is received.

According to some examples, after receiving the indication of the second set of reference signals, performing, using the second set of reference signals from the network, the failure detection of the functionality associated with the machine learning model during the failure detection cycle uses: both the first set of reference signals and the second set of reference signals for performing the failure detection.

According to some examples, the indication of the second set of reference signals comprises: an indication comprising a list of reference signals to use as the second set of reference signals

According to some examples, the indication comprises a medium access control element or downlink control information.

According to some examples, the indication of the second set of reference signals comprises: a triggering command indicating that channel state information reference signal transmission should be used as the second set of reference signals.

According to some examples, the at least one memory and the computer program code are configured to, with the at least one processor, cause the apparatus at least to perform: reporting at least one predicted beam to the network, wherein the indication of the second set of reference signals comprises an indication to use the at least one predicted beam as the second set of reference signals.

According to some examples, the performing, using the first set of reference signals and during the failure detection cycle, failure detection of the functionality associated with the machine learning model comprises at least one of: comparing predicted beams from the machine learning model with the first set of reference signals; comparing a measured Layer 1 Reference Signal Resource Indicator distribution of the first set of reference signals with an output distribution of the machine learning model.

According to some examples, the performing, using the measured second set of reference signals during the failure detection cycle, failure detection of the functionality associated with the machine learning model comprises at least one of: comparing predicted beams from the machine learning model with the second set of reference signals; comparing a measured Layer 1 Reference Signal Resource Indicator distribution of the second set of reference signals with an output distribution of the machine learning model.

According to some examples, the at least one memory and the computer program code are configured to, with the at least one processor, cause the apparatus at least to perform: sending, to the network, each model failure instance determined using the first set of reference signals; wherein the network determines to send the second set of reference signals based on the received model failure instances.

According to some examples, the second set of reference signals is based on a report, wherein the method comprises sending the report to the network, the report comprising at least one of the following: at least one strongest beam predicted using the machine learning model; Layer 1 Reference Signal Received Power of one or more beams predicted using the machine learning model; Channel State Information.

According to a fourth aspect there is provided an apparatus comprising: circuitry for: performing, using a first set of reference signals and during a failure detection cycle, failure detection of a functionality associated with a machine learning model; receiving an indication of a second set of reference signals from a network during the failure detection cycle; measuring the second set of reference signals during the failure detection cycle; performing, using the second set of reference signals and during the failure detection cycle, failure detection of the functionality associated with the machine learning model.

According to a fifth aspect there is provided a computer program comprising instructions for causing an apparatus to perform at least the following: performing, using a first set of reference signals and during a failure detection cycle, failure detection of a functionality associated with a machine learning model; receiving an indication of a second set of reference signals from a network during the failure detection cycle; measuring the second set of reference signals during the failure detection cycle; performing, using the second set of reference signals and during the failure detection cycle, failure detection of the functionality associated with the machine learning model.

According to a sixth aspect there is provided a computer program comprising instructions stored thereon for performing at least the following: performing, using a first set of reference signals and during a failure detection cycle, failure detection of a functionality associated with a machine learning model; receiving an indication of a second set of reference signals from a network during the failure detection cycle; measuring the second set of reference signals during the failure detection cycle; performing, using the second set of reference signals and during the failure detection cycle, failure detection of the functionality associated with the machine learning model.

According to a seventh aspect there is provided a non-transitory computer readable medium comprising program instructions for causing an apparatus to perform at least the following: performing, using a first set of reference signals and during a failure detection cycle, failure detection of a functionality associated with a machine learning model; receiving an indication of a second set of reference signals from a network during the failure detection cycle; measuring the second set of reference signals during the failure detection cycle; performing, using the second set of reference signals and during the failure detection cycle, failure detection of the functionality associated with the machine learning model.

According to an eighth aspect there is provided a non-transitory computer readable medium comprising program instructions stored thereon for performing at least the following: performing, using a first set of reference signals and during a failure detection cycle, failure detection of a functionality associated with a machine learning model; receiving an indication of a second set of reference signals from a network during the failure detection cycle; measuring the second set of reference signals during the failure detection cycle; performing, using the second set of reference signals and during the failure detection cycle, failure detection of the functionality associated with the machine learning model.

According to a ninth aspect there is provided an apparatus comprising: means for sending, during a failure detection cycle for performing failure detection of a functionality associated with a machine learning model and to a user equipment using a first set of reference signals to perform failure detection of a functionality associated with the machine learning model, an indication of a second set of reference signals to use to perform, during the failure detection cycle, the failure detection of the functionality associated with the machine learning model.

According to some examples, the apparatus comprises: means for sending, to the user equipment, an indication of the first set of reference signals and a time period for each failure detection cycle for performing the failure detection of the functionality associated with the machine learning model.

According to some examples, the indication of the second set of reference signals comprises an indication comprising a list of reference signals to use as the second set of reference signals.

According to some examples, the indication comprises a medium access control element or downlink control information.

According to some examples, the indication of the second set of reference signals comprises a triggering command indicating that channel state information reference signal transmission should be used as the second set of reference signals.

According to some examples, the indication of the second set of reference signals comprises: an indication to use at least one predicted beam reported from the user equipment as the second set of reference signals.

According to some examples, the apparatus comprises: means for receiving, from the user equipment, each model failure instance determined using the first set of reference signals;

means for determining to send the second set of reference signals based on the received model failure instances

According to some examples, the apparatus comprises: means for receiving a report from the user equipment; means for determining the second set of reference signals based on the report, the report comprising at least one of the following: at least one strongest beam predicted using the machine learning model; Layer 1 Reference Signal Received Power of one or more beams predicted using the machine learning model; Channel State Information.

According to a tenth aspect there is provided a method comprising: sending, during a failure detection cycle for performing failure detection of a functionality associated with a machine learning model and to a user equipment using a first set of reference signals to perform failure detection of a functionality associated with the machine learning model, an indication of a second set of reference signals to use to perform, during the failure detection cycle, the failure detection of the functionality associated with the machine learning model.

According to some examples, the method comprises: sending, to the user equipment, an indication of the first set of reference signals and a time period for each failure detection cycle for performing the failure detection of the functionality associated with the machine learning model.

According to some examples, the indication of the second set of reference signals comprises an indication comprising a list of reference signals to use as the second set of reference signals.

According to some examples, the indication comprises a medium access control element or downlink control information.

According to some examples, the indication of the second set of reference signals comprises a triggering command indicating that channel state information reference signal transmission should be used as the second set of reference signals.

According to some examples, the indication of the second set of reference signals comprises: an indication to use at least one predicted beam reported from the user equipment as the second set of reference signals.

According to some examples, the apparatus comprises: means for receiving, from the user equipment, each model failure instance determined using the first set of reference signals; means for determining to send the second set of reference signals based on the received model failure instances

According to some examples, the method comprises: receiving a report from the user equipment; means for determining the second set of reference signals based on the report, the report comprising at least one of the following: at least one strongest beam predicted using the machine learning model; Layer 1 Reference Signal Received Power of one or more beams predicted using the machine learning model; Channel State Information.

According to an eleventh aspect there is provided an apparatus comprising: at least one processor; and at least one memory including computer program code; the at least one memory and the computer program code configured to, with the at least one processor, cause the apparatus at least to perform: sending, during a failure detection cycle for performing failure detection of a functionality associated with a machine learning model and to a user equipment using a first set of reference signals to perform failure detection of a functionality associated with the machine learning model, an indication of a second set of reference signals to use to perform, during the failure detection cycle, the failure detection of the functionality associated with the machine learning model.

According to some examples, the at least one memory and the computer program code are configured to, with the at least one processor, cause the apparatus at least to perform: sending, to the user equipment, an indication of the first set of reference signals and a time period for each failure detection cycle for performing the failure detection of the functionality associated with the machine learning model.

According to some examples, the indication of the second set of reference signals comprises an indication comprising a list of reference signals to use as the second set of reference signals.

According to some examples, the indication comprises a medium access control element or downlink control information.

According to some examples, the indication of the second set of reference signals comprises a triggering command indicating that channel state information reference signal transmission should be used as the second set of reference signals.

According to some examples, the indication of the second set of reference signals comprises: an indication to use at least one predicted beam reported from the user equipment as the second set of reference signals.

According to some examples, the at least one memory and the computer program code are configured to, with the at least one processor, cause the apparatus at least to perform: receiving, from the user equipment, each model failure instance determined using the first set of reference signals; determining to send the second set of reference signals based on the received model failure instances

According to some examples, the at least one memory and the computer program code are configured to, with the at least one processor, cause the apparatus at least to perform: receiving a report from the user equipment; means for determining the second set of reference signals based on the report, the report comprising at least one of the following: at least one strongest beam predicted using the machine learning model; Layer 1 Reference Signal Received Power of one or more beams predicted using the machine learning model; Channel State Information.

According to a twelfth aspect there is provided an apparatus comprising circuitry for: sending, during a failure detection cycle for performing failure detection of a functionality associated with a machine learning model and to a user equipment using a first set of reference signals to perform failure detection of a functionality associated with the machine learning model, an indication of a second set of reference signals to use to perform, during the failure detection cycle, the failure detection of the functionality associated with the machine learning model.

According to a thirteenth aspect there is provided a computer program comprising instructions for causing an apparatus to perform at least the following: sending, during a failure detection cycle for performing failure detection of a functionality associated with a machine learning model and to a user equipment using a first set of reference signals to perform failure detection of a functionality associated with the machine learning model, an indication of a second set of reference signals to use to perform, during the failure detection cycle, the failure detection of the functionality associated with the machine learning model.

According to a fourteenth aspect there is provided a computer program comprising instructions stored thereon for performing at least the following: sending, during a failure detection cycle for performing failure detection of a functionality associated with a machine learning model and to a user equipment using a first set of reference signals to perform failure detection of a functionality associated with the machine learning model, an indication of a second set of reference signals to use to perform, during the failure detection cycle, the failure detection of the functionality associated with the machine learning model.

According to a fifteenth aspect there is provided a non-transitory computer readable medium comprising program instructions for causing an apparatus to perform at least the following: sending, during a failure detection cycle for performing failure detection of a functionality associated with a machine learning model and to a user equipment using a first set of reference signals to perform failure detection of a functionality associated with the machine learning model, an indication of a second set of reference signals to use to perform, during the failure detection cycle, the failure detection of the functionality associated with the machine learning model.

According to a sixteenth aspect there is provided a non-transitory computer readable medium comprising program instructions stored thereon for performing at least the following: sending, during a failure detection cycle for performing failure detection of a functionality associated with a machine learning model and to a user equipment using a first set of reference signals to perform failure detection of a functionality associated with the machine learning model, an indication of a second set of reference signals to use to perform, during the failure detection cycle, the failure detection of the functionality associated with the machine learning model.

According to an aspect, there is provided a non-transitory computer readable medium comprising program instructions that, when executed by an apparatus, cause the apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows an example method flow;

FIG. 2 shows an example apparatus;

FIG. 3 shows an example apparatus;

FIG. 4 shows a method flow diagram;

FIG. 5 shows a schematic representation of a non-volatile memory medium storing instructions which when executed by a processor allow a processor to perform one or more of the steps of the methods disclosed herein.

### DETAILED DESCRIPTION

In the following certain embodiments are explained with reference to mobile communication devices capable of communication via a wireless cellular system and mobile communication systems serving such mobile communication devices.

Using Artificial Intelligence (AI) and Machine Learning (ML) for New Radio (NR) air interface can be useful for increasing efficiency. Using AI and ML for the NR Air Interface is discussed in Release-183GP and RP-213599.

The air interface can be augmented with features enabling improved support of AI/ML-based algorithms for enhanced performance and/or reduced complexity/overhead. AI/ML could improve the performance of air-interface functions.

AI/ML enhancements related to beam management can support a reduced overhead and lower beam measurements and reporting latency. Two sub-use cases have been identified in RAN1: beam prediction in the spatial domain (BM-Case1) and beam prediction in the time domain (BM-Case2); see RAN1 #10.

BM-Case 1 relates to spatial-domain DL beam prediction for a first set of beams (set A) based on measurement results of a second set of beams (set B). The first set of beams may comprise beams that are not included in the second set of beams.

BM-Case 2 relates to time-domain DL beam prediction for a first set of beams (set A) based on historic measurement results of a second set of beams (set B). Again, the first set of beams may comprise beams that are not included in the second set of beams.

In some examples, spatial-domain and/or time-domain DL beam prediction may be performed using an AI/ML model at a User Equipment (UE).

AI/ML model monitoring is useful for both BM-Case1 and BM-Case 2. For example, signalling/configuration/measurement/report can be used for model monitoring. Model monitoring can be performed, for example, at a UE and the UE may make decision(s) for model selection, model activation, model deactivation, model switching or a fallback operation. According to some examples, a UE may monitor performance metrics and the network may make decisions of model selection/activation/deactivation/switching/fallback operation.

AI/ML models may comprise proprietary-format models. Proprietary-format models may comprise vendor/device specific proprietary formats. An example may comprise a device-specific binary executable format.

AI/ML models may comprise open-format models. Open-format models may comprise ML models of specified formant that are mutually recognizable across vendors.

Model identification may comprise, in some examples, a process/method of identifying an AI/ML model for the common understanding between the network (NW) and the UE. Functionality identification may comprise, in some examples, a process/method of identifying an AI/ML functionality for the common understanding between the NW and the UE.

Model monitoring (e.g., AI/ML model monitoring) can be considered to comprise a method that monitors inference performance of an AI/ML model. Model monitoring may comprise beam prediction sub-use cases, e.g., BM-Case1 and BM-Case 2. In some examples, the model may be applied at a UE (at a UE side relative to the NW).

Model monitoring may also refer to performance monitoring or functionality monitoring, where the use of the AI/ML model (or models) when supporting a ML-enabled feature, e.g., BM-Case1, or a ML functionality may be monitored. In some examples, functionality often refers to the high-level description of the ML model or usage conditions/tasks (referred also as applicable conditions) of the ML model or to a logical ML model (which can be an abstract description of the physical ML model, where the physical model may refer to a data-driven executable format of an algorithmic), which often enables the network to identify the ML model used at the UE and enable signalling to manage the operations associated with the ML model usage.

In BM-Case1, a UE uses a limited set of beam measurements (set B) as the input of an ML model and the ML model predicts the best beams from a bigger set of beams (set A) that contains beams that are not measured by the UE beams. In another variant, a UE uses a different set of beam measurements (set B, wide beams or SSB beams) as the input of an ML model and the ML model predicts the best beams from another set of beams (set A, narrow beams or CSI-RS beams) that contains beams that are not measured by the UE beams. Best beams can be considered to comprise the strongest beams at the UE (e.g., the beams with the highest L1-RSRP at the UE). Best beams are often beams most optimally directed towards the UE. As with many other ML applications, the model accuracy or probability of having errors during the inference stage of the model can be high, especially when changes in radio parameters/conditions occur in the network. Model monitoring may be useful in some cases, e.g., in handover, before using the model in new radio environments/conditions/parameters. The use of a set of DL RSs (beams) for frequent model monitoring is considered as an option for model monitoring. With frequent measurements of a set of DL RSs, the predicted output can be compared with the ground truth measurements. According to some examples, a framework that allows the network to see variations in the model/functionality performance and determine the model/functionality accuracy from various dimensions is provided.

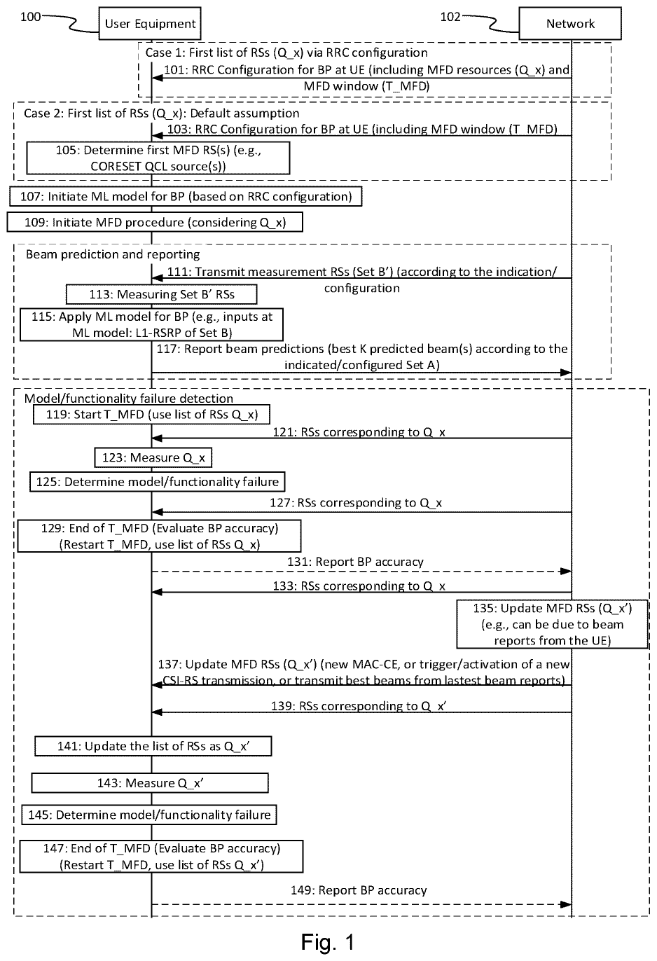

FIG. 1 shows an example message flow between a UE 100 and network 102 for model failure detection. The network 102 may comprise a network node.

101 provides a first case for a UE to determine Model Failure Detection (MFD) resources and 103 to 105 provides a second case for a UE to determine MFD resources.

At 101, network 102 provides an RRC configuration for Beam Prediction (BP) at UE 100. The RRC configuration includes MFD resources Q_x. Q_x comprise a list of Reference Signals (RSs) that can be used for MFD. The RRC configuration also includes an MFD window T_MFD which provides a time period in which MFD should be calculated by UE 100. MFD window T_MFD may be considered to comprise a failure detection cycle.

As an alternative to the first case at 101, at 103 network 102 sends UE 100 an RRC configuration for Beam Prediction (BP) at UE 100, including T_MFD but not Q_x. At 105, UE 100 then determines MFD RS(s) to initially use as Q_x. These MFD RS(s) could comprise, for example, CORESET Quasi-Colocation (QCL) source(s).

At 107, UE 100 initiates an ML model for Beam Prediction. The selected ML model may be base don the RRC configuration received at 101 or 103.

At 109, UE 100 initiates a MFD procedure using Q_x determined at 101 or 105.

111 to 117 shows a method for BP and reporting to the network. At 111, network 102 sends measurement RSs (set B′) according to the configuration sent at either 101 or 103.

At 113, the set B′ RSs are measured at UE 100. At 115, using the set B′ RS measurements from 113, an ML model is applied to predict the best beams for a larger set A of beams. Set B is a subset of set A. The ML model to be used at 115 may be signalled at 101 or 103. The inputs to be used may also be signalled. For example, L1-RSRP (Layer 1—Reference Signal Received Power) measurements of set B can be used as an input to the ML model at 115. Set B′ comprises set B. In some examples, set B′ is has more data than set B. In some examples, set B′=set B.

At 117, based on the ML model results from 115, UE 100 reports the best K predicted beams for set A to network 102. K is a positive integer. Set A and set B can be configured at 101 or 103 according to some examples.

119 to 149 shows a method for MFD, initiated at 109.

At 119, the time period T_MFD starts using Q_x (as determined for example at 101 or 103/105). At 121, UE 100 receives RSs (including RSs corresponding to Q_x) and measures the RSs based on the list of RSs in Q_x at 123. The time period T_MFD can be considered by a MAC entity corresponding to the functionality associated with the beam prediction and reporting.

At 125, UE 100 may detect model/functionality failure based on either measuring the set of RSs Q_x and comparing the measurements with model input/output parameters or based on link quality metrics. There are multiple possible ways model functionality/failure could be detected, but some options include:
Beam prediction accuracy-related methods, e.g., Beam set Q_x and predicted beams of Set A (Top-K beams or top-1 beam) are compared to derive accuracy metrics (and further compare it with certain predefined/configured thresholds).
Link quality-related methods, e.g., throughput, L1-RSRP, L1-SINR (L1-Signal to Noise Ratio), and hypothetical block error rate (BLER) may be derived based on Q_x measurements and compared with certain predefined/configured thresholds.
Performance metric based on input/output data distribution of AI/ML. E.g., the L1-RSRP distribution of Q_x may be compared with the trained model input or output distributions
The L1-RSRP difference was evaluated by comparing measured RSRP and predicted RSRP. E.g., if the Model provides predicted L1-RSRP for best-K beams, the Q_x measurements can be compared with it to derive metrics.

In some examples, model functionality/failure detected by the above methods may refer to a failure observed at the physical layer or for the model usage, and such a failure may be directly used or re-mapped to a failure considered in the Medium Access Control (MAC) entity. In one variant, if the accuracy-related metric (e.g., Top-K beam prediction) is below a pre-defined threshold, a failure may be counted for model usage or functionality, and the MAC entity may consider the same failure for the failure count considered in the MAC entity for the corresponding functionality. In another variant, if the accuracy-related metric (Top-K beam prediction) is below a pre-defined threshold, a failure may be counted for model usage or functionality, and the MAC entity may consider remapping of failures in the physical layer to failures considered in the MAC entity, e.g., multiple failures for model usage or functionality may be considered as a single failure count in the MAC entity if the failures occur within the sub-level of time window considered within the time period T_MFD.

Q_x may be a subset of set A, or in some examples could be different set that is not a subset of set A.

At 127, network 102 continues to send RSs corresponding to Q_x to UE 100. At 129, T_MFD ends, and BP accuracy is evaluated by UE 100. A new timer duration for T_MFD may start using the list of RSs Q_x for MFD. BP accuracy may be performed by comparing beams set C and predicted beams of Set A (e.g., Top-K beams) to determine accuracy metrics. These metrics may in some examples be compared to predefined/configured thresholds.

At 131, UE 100 may optionally report BP accuracy to network 102. At 133, network 102 continues to send RSs corresponding to Q_x to UE 102.

At 135, network 102 determines to update the list of RSs to use for MFD. Network 102 may determine a new list of RSs to use for MFD as Q_x′. The determination at 135 may be based on beam reports received at 117 and/or based on BP accuracy reports received at 131. When UE 100 predicts the best beams based on the ML model, the model failures are determined over a longer time (over a time cycle T_MFD) by counting a number of failure instances during T_MFD. Each failure instance may be determined based on the beam measurements for failure detection (1st set of beams). However, if we consider a fixed set, all failure instances may not show actual failures and some failures may be missed by UE 100, especially if UE 100 moves or the environment changes. In other words, some failure instances may not be actual failure instances (false alarms) and some instances may not be counted as failure instances (miss detection). To resolve this, network 102 can update the beam set (in this example from Q_x to Q_x′) used for failure detection and minimize false alarms or miss detections of failure instances. UE 100 could use both Q_x and Q_x′ together Q_x′ alone for failure count. According to some examples, the latest beam set is used as the first beam set for the next MFD cycle.

According to some examples, network 102 may determine Q_x′ based on one or more reports comprising at least one of the following:
predicted beams (e.g. top-K beams reported by UE 100)
predicted L1-RSRP (reported by UE 100).
other UE beam reports, where UEs assume non-ML (actual beam measurements)
reported CSI by UE 100 (or other UEs).

At 137, the updated list of MFD RSs, Q_x′, is sent to UE 100. Q_x′ may be sent using a Medium Access Control (MAC) Control Element (CE) or a Channel State Information Reference Signal (CSI-RS). In some examples, UE 100 may instead at 137 determine to use the best beams from the latest beam reports as Q_x′.

At 139, RSs corresponding to Q_x′ are sent from network 102 to UE 100.

At 141, UE 100 updates its list for measuring MFD to the list of RSs in Q_x′. At 143 UE 100 measures RSs corresponding to Q_x′. At 145, based on the measurements at 143, UE 100 determines whether the ML model has failed. This may be performed using a similar method to 125, but using Q_x′ measurements rather than Q_x measurements.

At 147 T_MFD ends and BP accuracy be evaluated by UE. A new T_MFD timer duration may then start, using Q_x′ for MFD. BP accuracy for 129 to 147 may optionally be reported from UE 100 to network 102 at 149.

Based on the above methods a UE can determine if an ML model being used for BP is performing well. If the ML model is not performing well, the ML model can be changed to provide a better performance, leading to more accurate BP predictions.

In the above-described method, for ML-based beam production (e.g., BM-Case1) with a UE-sided ML model, a given ML model or Model functionality shall use an associated list of reference signal resources (RSs) (which contains one or more reference signal resource (RS), e.g., CSI-RS, SSB) to determine a model/functionality failure detection for the given ML model or Model functionality (the ML model or functionality may be identified by an ID). UE 100 measures the list of RSs for a period of time T_MFD (for example at 123 and 143) in which UE 100 can determine the failure instances of the ML model or Model functionality. T_MFD is expected in some examples to be in a range of several milliseconds/seconds. The number of measurement instances on the list of RSs is often more than 1, where UE 100 can see the averaged performance of the ML model or model functionality.

In the above-described method of FIG. 1, UE 100 receives and/or considers an updated list of RSs Q_x′ as an alternative to the initial list of RSs Q_x (the list used at the beginning of the timer or time period for failure detection). It should be noted that in some examples UE 100 may consider Q_x and a new list of RSs Q_x at the same time (rather than considering them alternatively to one another). One or more of the following may be applied for reception and/or consideration at 137:
a new indication command (e.g., MAC-CE, DCI) may be received by UE 100 (for a given ML model or model functionality) which provides a list of RSs Q_x associated with a Model/Functionality failure detection. In some examples, an ID may also be included in the MAC-CE to identify the exact ML model or Model functionality)
the legacy framework of triggering/activating aperiodic/semi-persistent CSI-RS transmission may be used towards the UE considering a given ML model or model functionality, where CSI-RS transmissions may be identified/defined as the list of RSs for model/functionality failure detection.

In one example, triggering/activation command may indicate that a CSI-RS transmission at 137 is associated with an ML model or functionality failure detection. In another example, a given aperiodic (AP) CSI report may contain ML model or functionality failure detection-specific reporting quantities.

As mentioned above at 137, in some examples UE 100 considers RS(s) associated with the latest Kth (K=1, 2 . . . 3, defined/configured to the UE 100) beam reporting instance (e.g., reporting instance may carry best-predicted beams based on the ML model or model functionality used at UE 100) to be included in the updated list of RSs. This type of consideration may be defined or configured to the UE 100. The network 102 is expected to transmit these RS(s) for model/functionality monitoring purposes.

In one example, the updated listed RSs Q_x′ may correspond to the full/partial set of resources (beams) considered in the ML model prediction set (i.e., Set A beams).

In both 119 to 129 and 129 to 147, UE 100 uses a timer or time period for MFD. If the list of resources Q_x (or Q_x′) is not updated during the timer duration or time period T_MFD, the measurements of the list of resources used from the start of the timer/period (initial list of RSs Q_x) are considered when determining BP failure instances. In an example, L1-RSRP measurements of Q_x may be compared to a pre-defined threshold to determine the beam prediction failure instances. In an example, best-measured beams from Q_x measurements may be compared with the best-predicted from Model inference to determine the beam prediction failure instances.

If the list of resources Q_x (or Q_x′) is updated during the timer duration or time period T_MFD, in one example only the updated list of RSs may be used (considering the remaining duration of the timer or time period) when determining the beam prediction failure instances. In one example, L1-RSRP measurements of Q_x′ (updated set) may be compared to a pre-defined threshold to determine the beam prediction failure instances. In one example, the best-measured beams from Q_x′ (updated set) measurements may be compared with the best-predicted from Model inference to determine the beam prediction failure instances.

In another example, if the list of resources Q_x (or Q_x′) is updated during the timer duration or time period T_MFD, both the initial and updated list of RSs are considered when determining the beam prediction failure instances. In one example, L1-RSRP measurements of Q_x and Q_x′ (updated set) may be compared a pre-defined threshold to determine the beam prediction failure instances. In one example, best measured beams from Q_x and Q_x′ (updated set) measurements may be compared with the best-predicted from Model inference to determine the beam prediction failure instances. In another example, it is also possible to use weighted averaging among the failures associated with the initial and updated list of RSs, when determining MFD.

According to some examples, an initial list of RSs considered during a new timer duration or time period can be determined by the updated list of RSs coming from the earlier time period. For example, in the T_MFD started at 147, Q_x′ can be used as the list of RSs for the new timer duration.

According to some examples, the first (before any updates) list of RSs can be configured as pre-configured, where the pre-configuration is done prior to the use of the ML model or Model functionality. Periodic CSI-RS resources may be configured to the UE, where periodic CSI-RS resources may be a full/partial set of resources (beams) considered in the ML model prediction set (i.e., Set A beams) and the periodicity for transmitting these CSI-RS resources may be a larger value compared to measured beams (i.e., Set B).

According to some examples, the UE shall consider a default assumption for the RSs in the list of RSs prior to the use of the ML model or Model functionality. For example, UE 100 may assume DL RS(s) associated with the activated TCI state(s) for CORESETs and/or PDSCH reception to be included in the list of RSs associated with ML model or model functionality failure detection

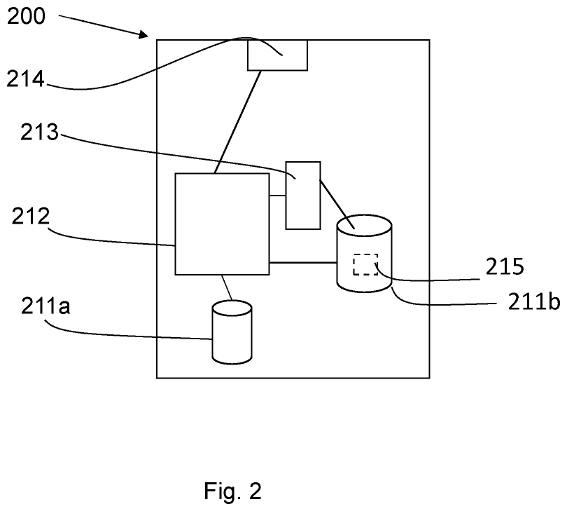

FIG. 2 illustrates an example of a control apparatus 200 for controlling a network. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the RAN or the core network.

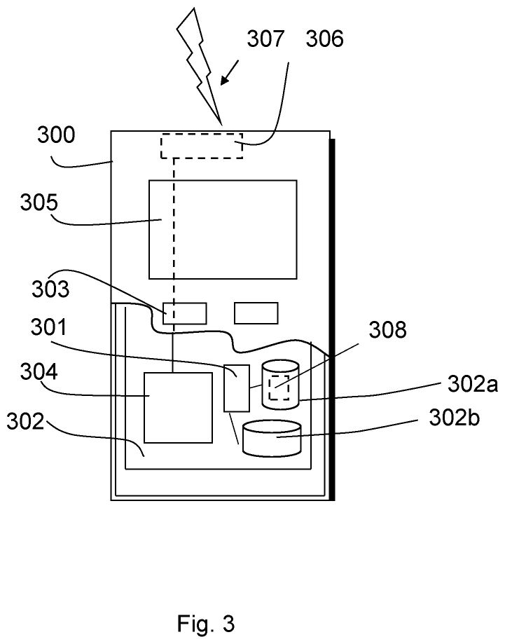

FIG. 3 illustrates an example of a terminal 300, such as a UE. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (IoT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

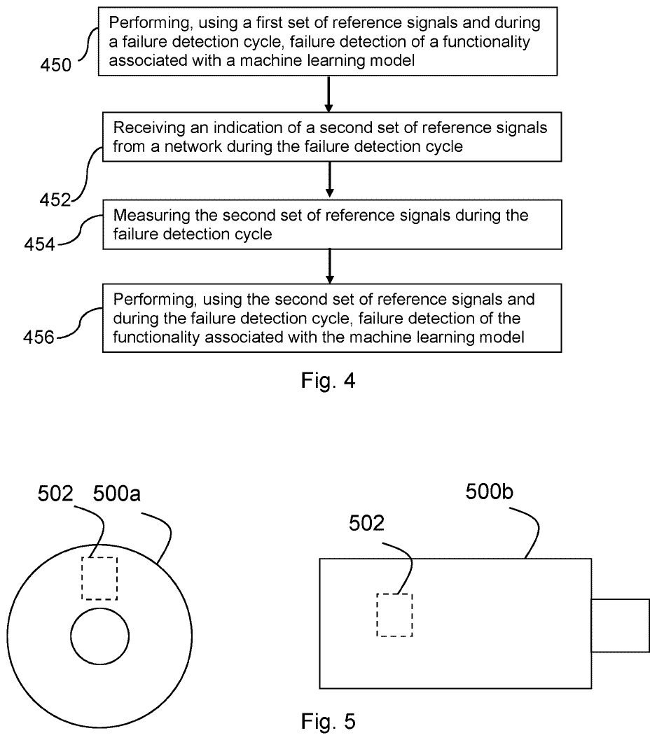

FIG. 4 shows an example method flow. The method of FIG. 4 may be performed by a UE (e.g., UE 100).

At 450, the method comprises performing, using a first set of reference signals and during a failure detection cycle, failure detection of a functionality associated with a machine learning model.

At 452, the method comprises receiving an indication of a second set of reference signals from a network during the failure detection cycle. In some examples, the indication is received from a network node, e.g., network 102.

At 454, the method comprises measuring the second set of reference signals during the failure detection cycle.

At 456, the method comprises performing, using the second set of reference signals and during the failure detection cycle, failure detection of the functionality associated with the machine learning model.

FIG. 5 shows a schematic representation of non-volatile memory media 500a (e.g. computer disc (CD) or digital versatile disc (DVD)) and 500b (e.g. universal serial bus (USB) memory stick) storing instructions and/or parameters 502 which when executed by a processor allow the processor to perform one or more of the steps of the above-described methods.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. An apparatus comprising:
at least one processor; and
at least one memory storing instructions that, when executed by the at least one processor, cause the apparatus to at least perform:
performing, using a first set of reference signals and during a failure detection cycle, failure detection of a functionality associated with a machine learning model;
receiving an indication of a second set of reference signals from a network during the failure detection cycle;
measuring the second set of reference signals during the failure detection cycle;
performing, using the second set of reference signals and during the failure detection cycle, failure detection of the functionality associated with the machine learning model.

2. An apparatus according to claim 1, wherein the apparatus is further caused to at least perform:
receiving, from the network, an indication of the first set of reference signals and a time period for each failure detection cycle for performing the failure detection of the functionality associated with the machine learning model, wherein the indication is used to determine the first set of reference signals.

3. An apparatus according to claim 1, wherein a Control Resource Set, CORESET, Quasi Co Location, QCL, resource is used to determine the first set of reference signals, wherein the apparatus is further caused to at least perform:
receiving, from the network, a time period for each failure detection cycle for performing the failure detection of the functionality associated with the machine learning model.

4. An apparatus according to claim 2, wherein after receiving the indication of the second set of reference signals, the apparatus is further caused to at least perform:
using the second set of reference signals from the network, the failure detection of the functionality associated with the machine learning model uses: only the second set of reference signals for performing the failure detection until an indication of a third set of reference signals is received.

5. An apparatus according to claim 2, wherein after receiving the indication of the second set of reference signals, the apparatus is further caused to at least perform:
using the second set of reference signals from the network, the failure detection of the functionality associated with the machine learning model during the failure detection cycle uses: both the first set of reference signals and the second set of reference signals for performing the failure detection.

6. An apparatus according to claim 1, wherein the indication of the second set of reference signals comprises:
an indication comprising a list of reference signals to use as the second set of reference signals

7. An apparatus according to claim 6, wherein the indication comprises a medium access control element or downlink control information.

8. An apparatus according to claim 1, wherein the indication of the second set of reference signals comprises: a triggering command indicating that channel state information reference signal transmission should be used as the second set of reference signals.

9. An apparatus according to claim 1, wherein the apparatus is further caused to at least perform:
reporting at least one predicted beam to the network, wherein the indication of the second set of reference signals comprises an indication to use the at least one predicted beam as the second set of reference signals.

10. An apparatus according to claim 1, wherein the performing, using the first set of reference signals and during the failure detection cycle, failure detection of the functionality associated with the machine learning model comprises at least one of:
comparing predicted beams from the machine learning model with the first set of reference signals;
comparing a measured Layer 1 Reference Signal Resource Indicator distribution of the first set of reference signals with an output distribution of the machine learning model.

11. An apparatus according to claim 1, wherein the performing, using the measured second set of reference signals during the failure detection cycle, failure detection of the functionality associated with the machine learning model comprises at least one of:
comparing predicted beams from the machine learning model with the second set of reference signals;
comparing a measured Layer 1 Reference Signal Resource Indicator distribution of the second set of reference signals with an output distribution of the machine learning model.

12. An apparatus according to claim 1, wherein the apparatus is further caused to at least perform:
sending, to the network, each model failure instance determined using the first set of reference signals;
wherein the network determines to send the second set of reference signals based on the received model failure instances.

13. An apparatus according to claim 1, wherein the second set of reference signals is based on a report, wherein the apparatus is further caused to at least perform sending the report to the network, the report comprising at least one of the following:
at least one strongest beam predicted using the machine learning model;
Layer 1 Reference Signal Received Power of one or more beams predicted using the machine learning model;
Channel State Information.

14. A method comprising:
performing, using a first set of reference signals and during a failure detection cycle, failure detection of a functionality associated with a machine learning model;
receiving an indication of a second set of reference signals from a network during the failure detection cycle;
measuring the second set of reference signals during the failure detection cycle;
performing, using the second set of reference signals and during the failure detection cycle, failure detection of the functionality associated with the machine learning model.

15. (canceled)

16. An apparatus comprising:
at least one processor; and
at least one memory storing instructions that, when executed by the at least one processor, cause the apparatus to at least perform:
sending, during a failure detection cycle for performing failure detection of a functionality associated with a machine learning model and to a user equipment using a first set of reference signals to perform failure detection of a functionality associated with the machine learning model, an indication of a second set of reference signals to use to perform, during the failure detection cycle, the failure detection of the functionality associated with the machine learning model.

17. An apparatus according to claim 16, wherein the apparatus is further caused to at least perform:
sending, to the user equipment, an indication of the first set of reference signals and a time period for each failure detection cycle for performing the failure detection of the functionality associated with the machine learning model.

18. An apparatus according to claim 16, wherein the
indication of the second set of reference signals comprises an indication comprising a list of reference signals to use as the second set of reference signals.

19. An apparatus according to claim 18, wherein the indication comprises a medium access control element or downlink control information.

20. An apparatus according to claim 16, wherein the indication of the second set of reference signals comprises a triggering command indicating that channel state information reference signal transmission should be used as the second set of reference signals.

21. An apparatus according to claim 16, wherein the indication of the second set of reference signals comprises:
an indication to use at least one predicted beam reported from the user equipment as the second set of reference signals.

22-25. (canceled)
